(19) United States
(12) Patent Application Publication
(10) Pub. No.: US 2008/0099321 A1
(43) Pub. Date: May 1, 2008

(54) SWITCH

(75) Inventors: Yasuhiro Kiyono, Nagaokakyo-shi (JP); Toshihiro Naruo, Kyoto-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/877,304

(22) Filed: Oct. 23, 2007

(30) Foreign Application Priority Data
Oct. 31, 2006 (JP) 2006-295826

(51) Int. Cl. H01H 21/24

(52) U.S. Cl. 200/557

(57) ABSTRACT

A long-life switch includes a base in which fixed contact portions are exposed in a concentric manner in an upper surface thereof; an operation lever whose turning shaft center is disposed on a shaft center of a lever portion, and turnably supported along the upper surface of the base; a movable contact piece in which movable contact portions disposed at both ends of the movable contact piece are slidably disposed to the fixed contact portions; and a coil spring in which a shaft center of a coil portion is disposed eccentrically to a turning shaft center of the operation lever, the coil spring latching an arm portion extended from one end side of the coil portion to the upper surface of the base while swingably supporting the coil portion, the coil spring latching an arm portion extended from the other end side of the coil portion to the operation lever.

### BACKGROUND OF THE INVENTION

1. Field of the Invention

The present invention relates to a switch, particularly to a switch which is surface-mounted on a printed board.

2. Description of the Related Art

Conventionally, as for the switch surface-mounted on the printed board, there is proposed a switch wherein a returning spring member 3 is twisted to impart a returning force to a turning handle body 2 by turning the turning handle body 2 and an irregular shaped movable contact spring 4 formed by pressing of an elastic metal thin plate is rotated to open and close a contact (refer to, for example, Japanese Patent Application Laid-Open No. 2004-362979).

### SUMMARY OF THE INVENTION

However, as is clear from FIGS. 2 and 6 of Japanese Patent Application Laid-Open No. 2004-362979, in the switch, because a turning shaft center of the turning handle body 2 is matched with a turning shaft center of the returning spring member 3, a turning angle of the turning handle body 2 is always equal to an opening angle between end portions 3a and 3b of the returning spring member 3. As a result, when an operating angle of the turning handle body 2 is increased to facilitate the operation, the opening angle of the end portions 3a and 3b of the returning spring member 3 is increased to require a large operating force. Additionally, a load applied to the returning spring member 3 is increased and fatigue is easy to occur, which results in a problem of a short lifetime.

In view of the foregoing, an object of the present invention is to provide a long-life switch which can be operated by a small operating force.

In order to achieve the above object, an aspect according to the present invention provides a switch including a base in which a plurality of fixed contact terminals are insert-molded, fixed contact portions of the fixed contact terminals are exposed in a concentric manner in an upper surface thereof; an operation lever whose turning shaft center is disposed on a shaft center of a lever portion, the operation lever being turnably supported along the upper surface of the base; a movable contact piece in which movable contact portions disposed at both ends of the movable contact piece are slidably disposed to the fixed contact portions; and a coil spring in which a shaft center of a coil portion is disposed eccentrically to the turning shaft center of the operation lever, the coil spring latching an arm portion extended from one end side of the coil portion to the upper surface of the base while swingably supporting the coil portion, the coil spring latching an arm portion extended from the other end side of the coil portion to the operation lever while pressing the movable contact piece against the upper surface of the base to impart a contact force, the coil spring imparting a returning force to the operation lever, wherein the movable contact portion of the movable contact piece is brought into contact with and separated from the fixed contact portion to switch an electric circuit by turning the operation lever against a spring force of the coil spring, the movable contact portion being integrally turned according to the turning of the operation lever.

According to the aspect of the present invention, the turning shaft center of the swingably supported coil spring is disposed eccentrically to the operation lever. When the operation lever is turned to turn the arm portion of the coil spring, the coil portion of the coil spring is swung, and an opening angle of the arm portion in the coil spring is smaller than a turning angle of the operation lever. Therefore, because the spring force of the coil spring is not directly proportional to the turning angle of the operation lever, the operation lever can be operated with smaller operating force. Additionally, because the arm portion of the coil spring has the smaller opening angle, the small load is applied to the coil spring. Therefore, the fatigue is difficult to occur to lengthen the lifetime.

In the switch according to the aspect of the present invention, preferably the pair of arm portions extended from both end sides of the coil spring are extended while being able to clamp an operating rib of the operation lever. Because rattling is not generated between the coil spring and the operation lever, time lug is not generated in response speed, and the switch having good response can be obtained.

In the switch according to another aspect of the present invention, preferably a latching position where the arm portion is latched in the base is located closer to the turning shaft center of the operation lever than a latching position where the arm portion is latched in the operating rib of the operation lever.

The bending moment to the arm portion based on the operating rib projected from the operation lever is larger than the bending moment to the arm portion latched in the base. Therefore, the coil spring is easily swung, and smooth operating feeling is obtained.

### BRIEF DESCRIPTION OF THE DRAWINGS

FIG. 1 shows a perspective view of a switch according to a first embodiment of the present invention;

FIG. 2 shows an exploded perspective view of the switch shown in FIG. 1;

FIG. 3A shows a perspective view of a base shown in FIG. 2, and FIG. 3B shows a perspective view of only a fixed contact terminal shown in FIG. 3A;

FIGS. 4A to 4C show perspective views for explaining a method of assembling the switch according to the present invention;

FIG. 5A shows a plan view of the switch in which a cover is taken out, and FIG. 5B shows a sectional view taken on a line A-A of a state in which the base of FIG. 5A is attached to the cover;

FIGS. 6A to 6C show plan views for explaining a method of operating the switch according to the present invention;

FIGS. 7A to 7C show plan views for explaining another method of operating the switch according to the present invention;

FIGS. 8A and 8B show schematic views for explaining an action of the switch according to the present invention, and FIGS. 8C and 8D show schematic views for explaining an action of a switch according to a comparative example;

FIG. 9 shows a perspective view of a switch according to a second embodiment of the present invention;

FIG. 10A shows a perspective view of the base shown in FIG. 9, and FIG. 10B shows a perspective view of a fixed contact terminal shown in FIG. 10A; and

FIG. 11A shows a plan view of the switch in which the cover is taken out, and FIG. 11B shows a sectional view taken on a line A-A of a state in which the base of FIG. 11A is attached to the cover.

### DETAILED DESCRIPTION OF THE PREFERRED EMBODIMENTS

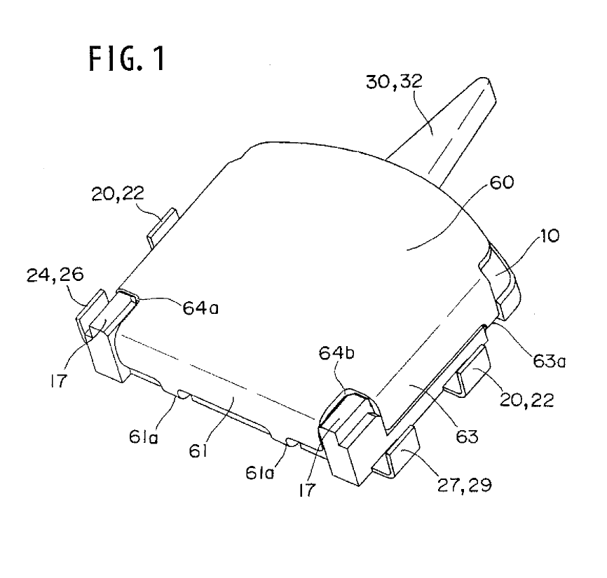

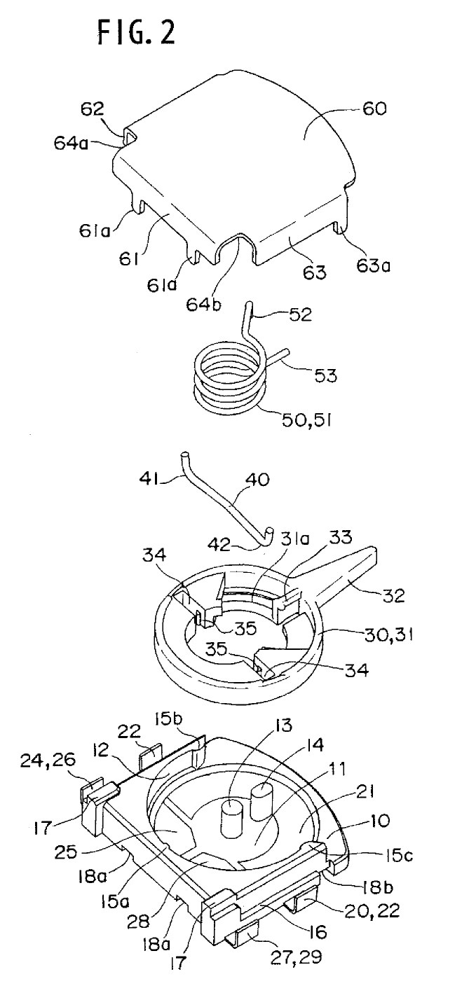

Preferred embodiments of the present invention will be described with reference to the accompanying drawings of FIGS. 1 to 11. As shown in FIGS. 1 to 8, a first embodiment is based on application to a compact switch surface-mounted on a printed board. As shown in FIG. 2, the switch includes a base 10, an operation lever 30, a movable contact piece 40, a coil spring 50, and a cover 60. The base 10 has a substantially square shape in plan view, and a common fixed contact terminal 20 and a pair of switching fixed contact terminals 24 and 27 are insert-molded in a bottom surface of the base 10. The operation lever 30 is turnably supported along an upper surface of the base 10. The movable contact piece 40 is formed by a bent rod-shape conductive spring member, and the movable contact piece 40 is fitted in fitting grooves 34 of the operation lever 30. The coil spring 50 presses the movable contact piece 40 to impart a contact pressure. The base 10 is covered with the cover 60, and the cover 60 compresses the coil spring 50.

In one example of the actually assembled product of the switch, an outside dimension has an overall height of 0.9 mm, a base width of 4.0 mm, and a base length of 3.9 mm.

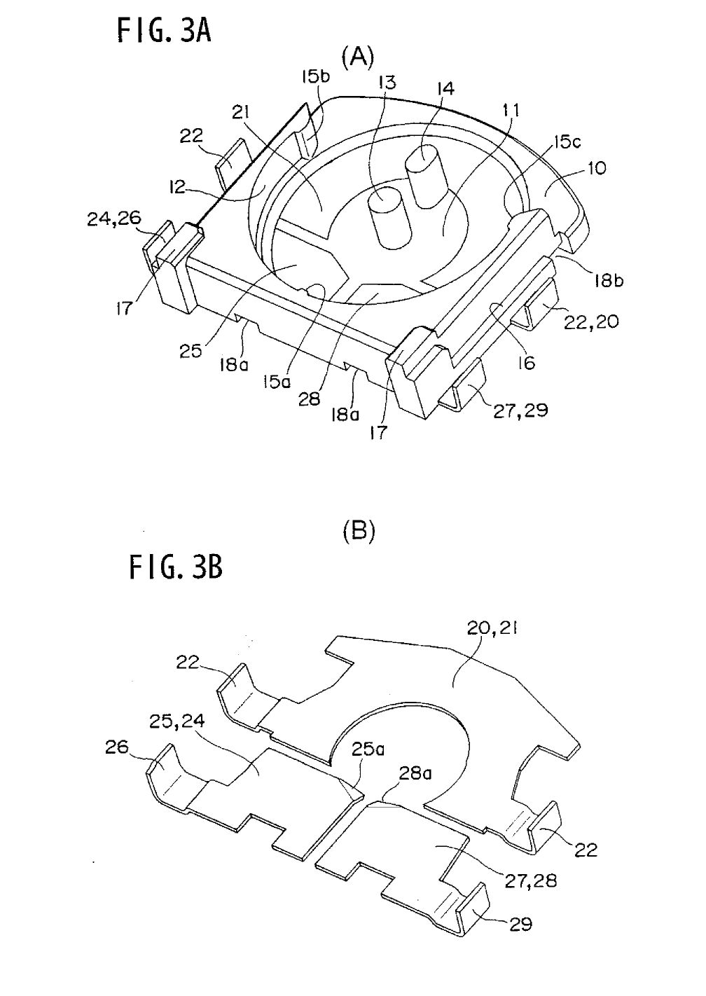

As shown in FIG. 3, in the base 10, a shallow and circular recess 11 is made in a central portion of the upper surface, and a substantially C-shape sidewall 12 is vertically provided along an opening edge portion. A stiffening projection 13 and a supporting projection 14 are provided in the central portion of the bottom surface of the recess 11. The stiffening projection 13 prevents deformation of the cover 60, and the supporting projection 14 stops rotations of arm portions 51 and 52 of the coil spring 50. Fixed contact portions 21, 25, and 28 of the insert-molded common fixed contact terminal 20 and switching fixed contact terminals 24 and 27 are discontinuously exposed in a concentric manner along a circumferential corner portion of the bottom surface of the recess 11. Positioning ribs 15a, 15b, and 15c are projected at predetermined intervals in an inner circumferential surface of the sidewall 12 in order to support the turning of the operation lever 30. Guiding step portions 16 are formed in opposing outside surfaces of the sidewall 12, and retaining projections 17 and 17 are formed in corner portions of an upper end face. Notches 18a and 18b are formed in an edge portion of the lower surface of the base 10 in order to latch a latching pawl of the cover 60.

As shown in FIG. 3B, in the common fixed contact terminal 20, terminal portions 22 and 22 are formed by upwardly bending both side edge portions of the common fixed contact portion 21 exposed from the bottom surface of the recess 11 of the base 10. In the switching fixed contact terminals 24 and 27, terminal portions 26 and 29 are formed by upwardly bending the edge portion on one side of each of the switching fixed contact portions 25 and 28 exposed from the bottom surface of the recess 11 of the base 10. Corner portions 25a and 28a of the switching fixed contact portions 25 and 28 are bent downward to prevent uplift after the insert molding.

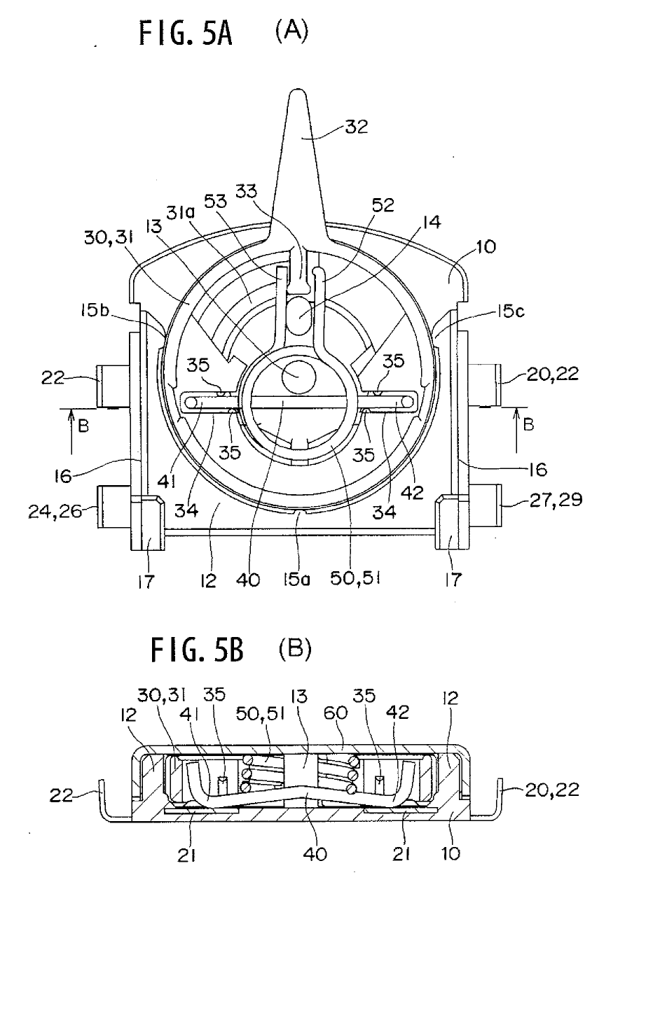

As shown in FIGS. 2 and 5A, the operation lever 30 includes a ring-shape lever body 31 and a lever portion 32. The lever body 31 can be turnably fitted in the recess 11 of the base 10. The lever portion 32 is projected from the outer circumferential surface of the lever body 31. In the inside surface of the lever body 31, an operating rib 33 is projected so as to be located on a shaft center of the lever portion 32, and a holder 31a is extended from the operating rib 33 to support an arm portion 53 of the coil spring 50, which will be described later. The fitting grooves 34 are made in the inside edge portion of the lever body 31, and the movable contact piece 40 is fitted in the fitting grooves 34. A positioning rib 35 is projected in the inside surface of the fitting groove 34 to prevent the movable contact piece 40 from rattling.

As shown in FIGS. 2 and 5B, in the movable contact piece 40, the central portion of the rod-shape conductive spring member is bent upward, and corner portions in which both end portions are bent upward constitute movable contact portion 41 and 42. The movable contact piece 40 is fitted in the fitting grooves 34 of the operation lever 30. The movable contact piece 40 is not limited to the rod member having the circular section, but a rod member having a square section and a rod member having a hexagonal section may be used as the movable contact piece 40.

As shown in FIG. 2, the coil spring 50 imparts the contact pressure to the movable contact piece 40, and the coil spring 50 imparts a returning force to the operation lever 30. In the coil spring 50, a pair of arm portions 52 and 53 is extended toward a substantially perpendicular direction from both ends of the cylindrical coil portion 51 so as to be in parallel to each other. Particularly, a front end of the arm portion 52 is bent downward.

As shown in FIG. 2, sidewalls 61, 62, and 63 are formed by folding three adjacent sides of the outer circumferential edge portion, whereby the cover 60 has a substantially square plane shape with which the base 10 can be covered. Engaging pawls 61a, 62a, and 63a are projected in the edge portions of the lower sides of the sidewalls 61, 62, and 63 respectively. Engaging notches 64a and 64b are formed in a corner portion located between the sidewalls 61 and 62 and in a corner portion located between the sidewalls 61 and 63 respectively.

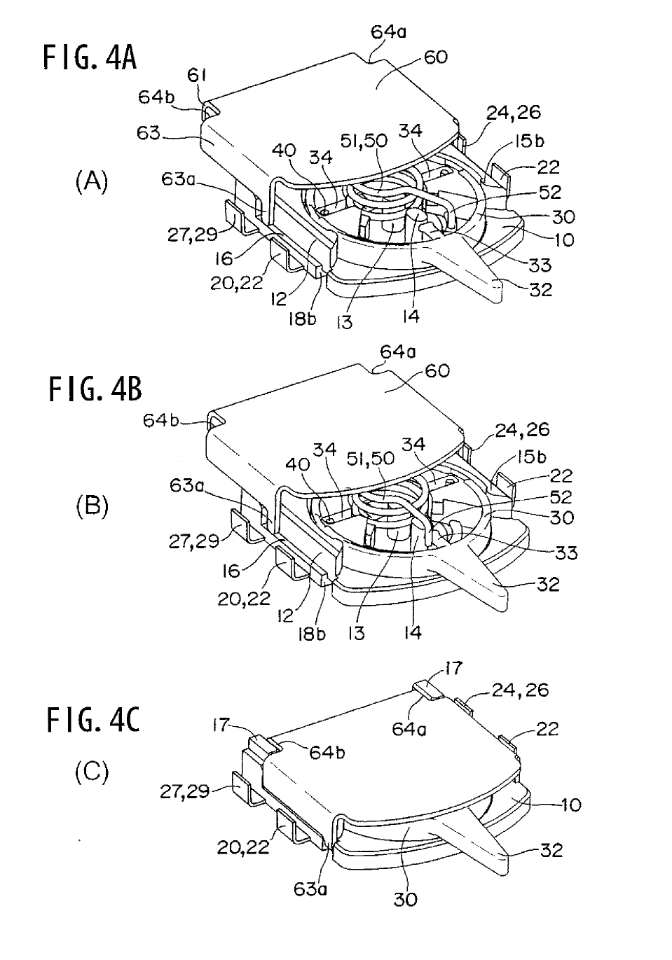

As shown in FIGS. 2 and 4, in order to assemble the switch according to the first embodiment, the operation lever body 31 of the operation lever 30 is fitted in the recess 11 of the base 10 in which the fixed terminals 20, 24, and 27 are insert-molded. The movable contact piece 40 is fitted in the fitting grooves 34 provided in the operation lever body 31, and the movable contact portions 41 and 42 of the movable contact piece 40 are assembled while being able to be brought into contact with and separated from the fixed contact portions 21, 25, and 28. Then, when the coil portion 51 of the coil spring 50 is fitted in the operation lever body 31, the arm portion 53 is placed on the support portion 31a of the operation lever 30 and the arm portions 52 and 53 are located in one of the supporting projection 14 and the operating rib 33. The base 10 is covered from above with the cover 60, and the coil spring 50 is compressed by downwardly pressing a lower half of the coil portion 51 of the coil spring 50. At this point, the arm portion 52 is latched by the operating rib 33 (FIG. 4A). Then, the arm portion 52 is elastically deformed to cross over the operating rib 33 (FIG. 4B), and the cover 60 is slide-moved along the guiding step portion 16, where by the whole of coil portion 51 is pressed downward. The latching pawls 61a, 62a, and 63a of the cover 60 are folded and latched in the notches 18a, 18b, and 18a respectively, and the assembly is completed (FIG. 4C). In the first embodiment, the cover 60 hardly drops off from the base 10 because the engaging notches 64a and 64b of the cover 60 are engaged with the retaining projections 17 and 17 of the base 10.

According to the first embodiment, the cover 60 presses and compresses the coil spring 50 to bias the movable contact piece 40, which enables the movable contact portions 41 and 42 to come into contact with the fixed contact portions 21, 25, and 28 at a predetermined contact pressure. Therefore, the desired contact reliability can be ensured. In the first embodiment, components such as the operation lever 30, the movable contact piece 40, and the coil spring 50 can be assembled from above in the base 10. Therefore, there is an advantage of easy production.

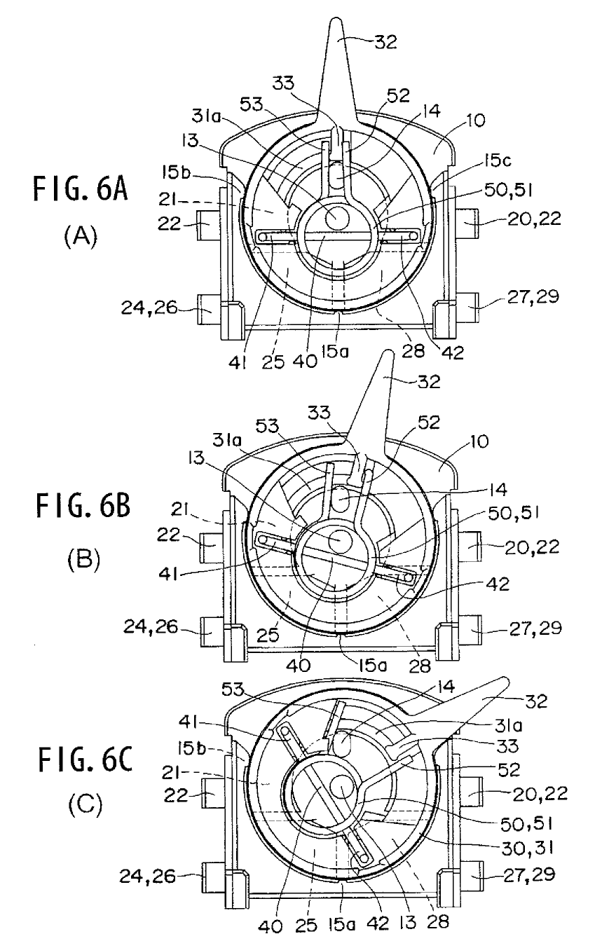

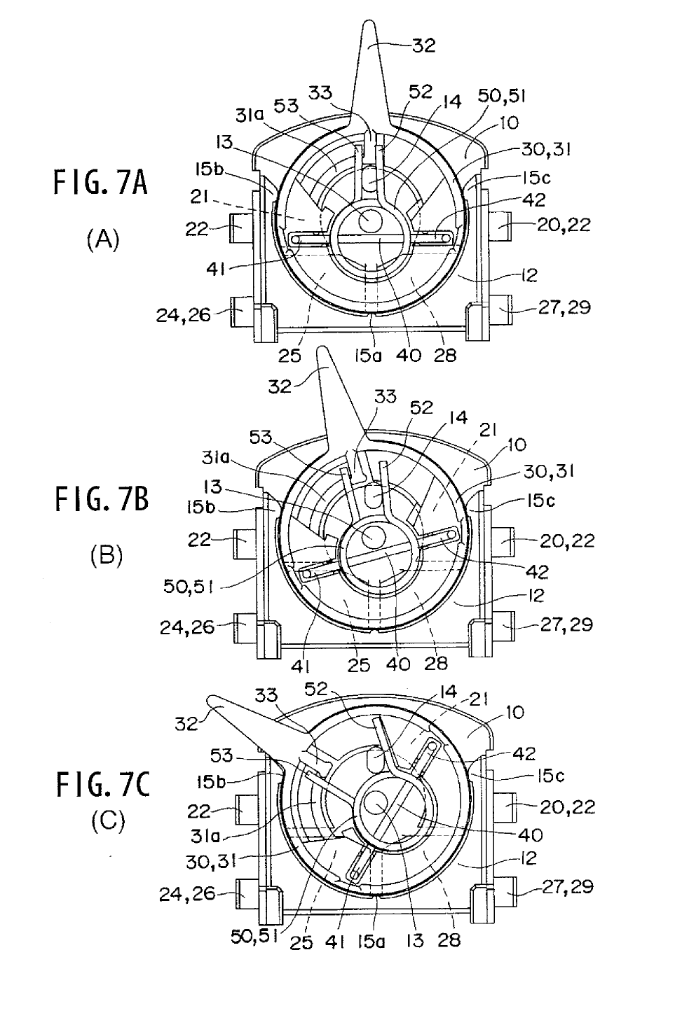

Then, a method of operating the switch will be described with reference to FIGS. 6 and 7. As shown in FIG. 6A, in the case where a load is not applied to the lever portion 32 of the operation lever 30, both the movable contact portions 41 and 42 of the movable contact piece 40 are in contact with the fixed contact portion 21. When an external force is applied to the lever portion 32 from the left, the operation lever 30 supported by the ribs 15a, 15b, and 15c of the sidewall 12 is turned clockwise, and the operation lever 30 abuts on one end portion of the sidewall 12 to stop the turning. At this point, because the arm portion 53 is latched by the supporting projection 14, the operating rib 33 of the operation lever 30 presses the arm portion 52 against the spring force of the coil spring 50, and the coil portion 51 is twisted. Therefore, a counterclockwise biasing force is generated in the operation lever 30, the movable contact portion 42 is switched from the fixed contact portion 21 to the fixed contact portion 28, and the common fixed contact terminal 20 and the switching fixed contact terminal 27 are electrically connected. When the load applied to the operation lever 30 is released, the operation lever 30 is returned to the original state by the spring force of the coil spring 50, and the movable contact portion 42 is switched from the fixed contact portion 28 to the fixed contact portion 21 and returned to the original state.

On the other hand, as shown in FIG. 7A, when the external force is applied to the lever portion 32 from the right, the operation lever 30 supported by the ribs 15a, 15b, and 15c of the sidewall 12 is turned counterclockwise, and the operation lever 30 abuts on one end portion of the sidewall 12 to stop the turning. At this point, because the arm portion 52 is latched by the supporting projection 14, the operating rib 33 of the operation lever 30 presses the arm portion 53 against the spring force of the coil spring 50, and the coil portion 51 is twisted. Therefore, a clockwise biasing force is generated in the operation lever 30, the movable contact portion 41 is switched from the fixed contact portion 21 to the fixed contact portion 25, and the common fixed contact terminal 20 and the switching fixed contact terminal 24 are electrically connected. When the load applied to the operation lever 30 is released, the operation lever 30 is returned to the original state by the spring force of the coil spring 50, and the movable contact portion 41 is switched from the fixed contact portion 25 to the fixed contact portion 21 and returned to the original state.

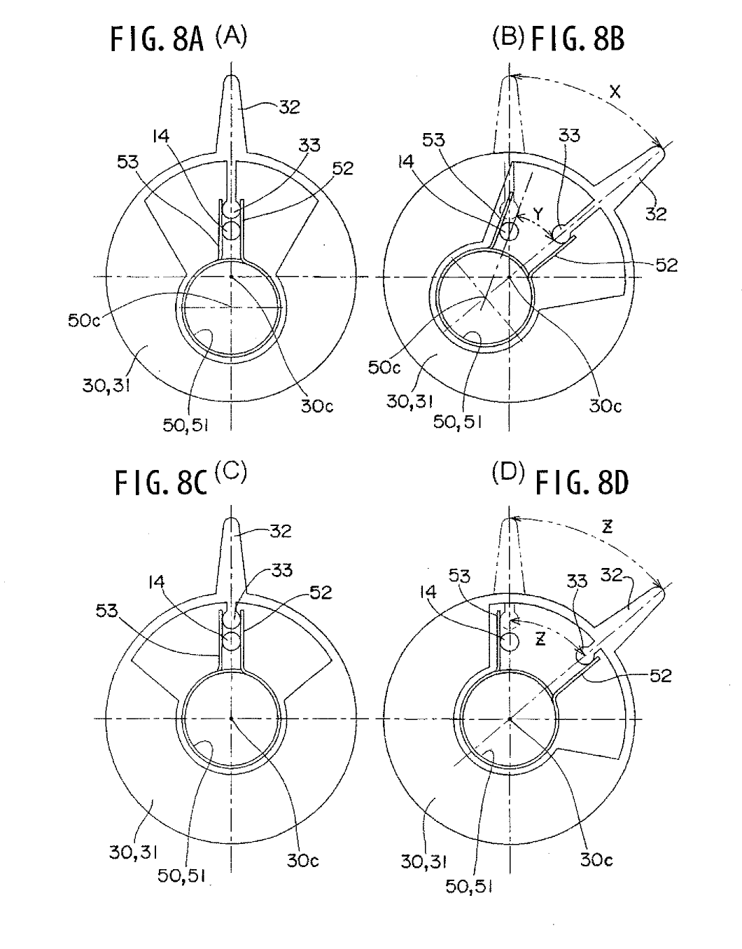

In the first embodiment, as shown in FIG. 8A, a turning center 50c of the coil spring 50 is disposed eccentrically to a turning center 30c of the operation lever 30, and the coil spring 50 is swingably supported. Therefore, as shown in FIG. 8B, when the operation lever 30 is turned about the turning center 30c to cause the operating rib 33 to press the arm portion 52, the coil portion 51 of the coil spring 50 is swung about the projection 14. As a result, as shown in FIG. 8B, an opening angle Y between the arm portions 52 and 53 is smaller than a turning angle X of the operation lever 30. On the other hand, as is clear from the comparative example shown in FIGS. 8C and 8D, in the case where the turning center of the operation lever 30 is matched with the turning center of the coil spring 50, a turning angle Z of the operation lever 30 is equal to an opening angle Z between the arm portions 52 and 53. Therefore, according to the first embodiment, when the turning angle Z of the operation lever 30 is equal to the opening angle Z, advantageously the operation can be performed with an operating force smaller than that of the comparative example, and fatigue is difficult to occur to lengthen a lifetime because stress of coil spring 50 becomes small.

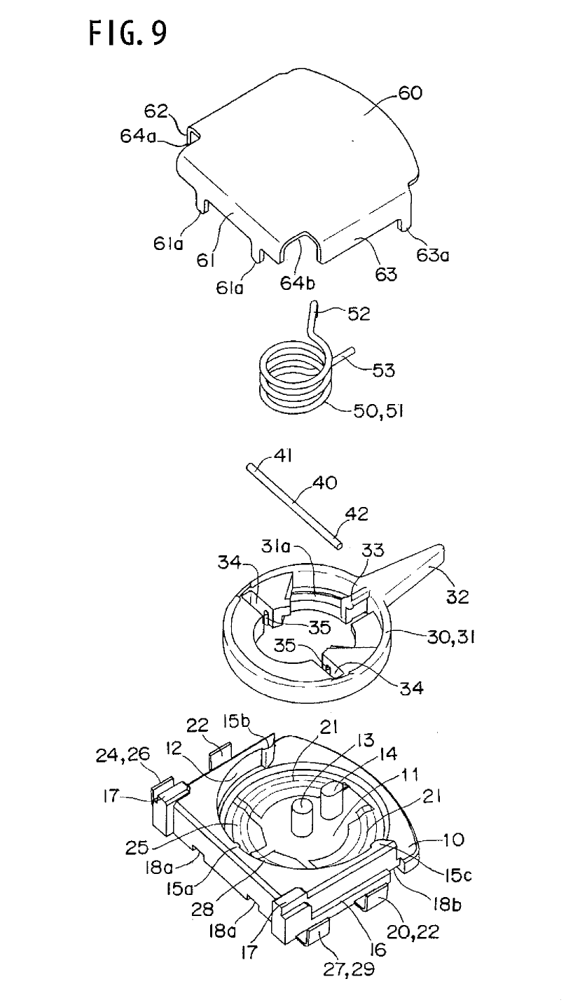

As shown in FIGS. 9 to 11, a second embodiment according to the present invention is similar to the first embodiment except for the shapes of the common fixed contact terminal 20, switching fixed contact terminals 24 and 27, and movable contact piece 40.

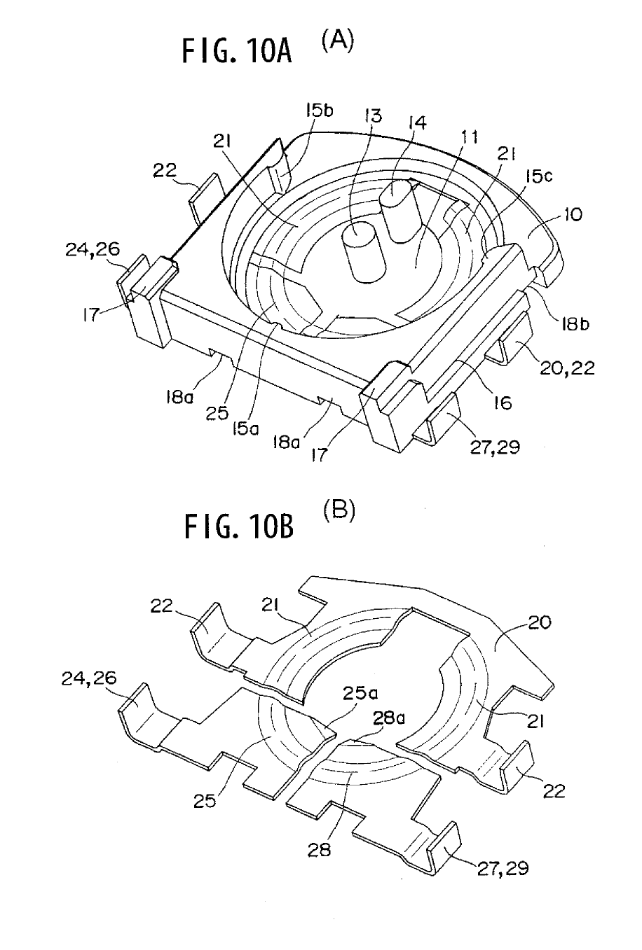

As shown in FIG. 10, the common fixed contact terminal 20 and the fixed contact portions 21, 25, and 28 of the switching fixed contact terminals 24 and 27 are insert-molded in the bottom surface of the base 10 and formed by ejection so as to form discontinuous annular projections.

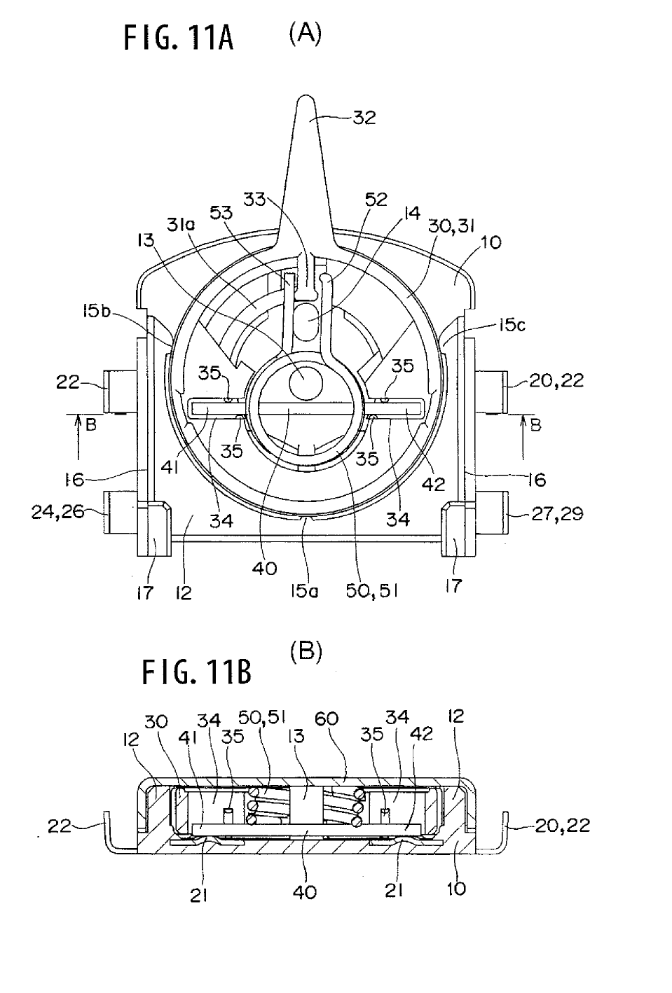

As shown in FIG. 11, the movable contact piece 40 is simply cut out from the rod-shape conductive spring member, and both ends portions of the movable contact piece 40 constitute the movable contact portions 41 and 42.

According to the second embodiment, advantageously it is not necessary that the movable contact piece 40 be folded in the complicated shape with high dimensional accuracy, which further facilitates the production to improve productivity. Because the basic structure is substantially similar to that of the first embodiment, the same component is designated by the same numeral, and the description is omitted.

The present invention is not limited to the above-described switch, but the invention can be applied to various switches.

1. A switch comprising:
a base in which fixed contact portions of fixed contact terminals are exposed in a concentric manner in an upper surface thereof;
an operation lever whose turning shaft center is disposed on a shaft center of a lever portion, the operation lever being turnably supported along the upper surface of the base;
a movable contact piece in which movable contact portions disposed at both ends of the movable contact piece are slidably disposed to the fixed contact portions; and
a coil spring in which a shaft center of a coil portion is disposed eccentrically to the turning shaft center of the operation lever, the coil spring latching an arm portion extended from one end side of the coil portion to the upper surface of the base while swingably supporting the coil portion, the coil spring latching an arm portion extended from the other end side of the coil portion to the operation lever while pressing the movable contact piece against the upper surface of the base to impart a contact force, the coil spring imparting a returning force to the operation lever,
wherein the movable contact portion of the movable contact piece is brought into contact with and separated from the fixed contact portion to switch an electric circuit by turning the operation lever against a spring force of the coil spring, the movable contact portion being integrally turned according to the turning of the operation lever.

2. The switch according to claim 1, wherein the pair of arm portions extended from both end sides of the coil spring are extended while being able to clamp an operating rib of the operation lever.

3. The switch according to claim 1, wherein a latching position where the arm portion is latched in the base is located closer to the turning shaft center of the operation lever than a latching position where the arm portion is latched in the operating rib of the operation lever.

4. The switch according to claim 2, wherein a latching position where the arm portion is latched in the base is located closer to the turning shaft center of the operation lever than a latching position where the arm portion is latched in the operating rib of the operation lever.
